(19) United States
(12) Patent Application Publication
(10) Pub. No.: US 2003/0061341 A1
(43) Pub. Date: Mar. 27, 2003

(54) Media cross conversion interface

(75) Inventors: Lawrence Loh, San Jose, CA (US); Nicolas Mauget, Paris (FR)

Correspondence Address: Brinks Hofer Gilson & Lione, P.O. Box 10395, Chicago, IL, 60610, US

(73) Assignee: Infineon Technologies North America Corp.

(21) Appl. No.: 09/964,942

(22) Filed: Sep. 26, 2001

(51) Int. Cl. G06F 15/16

(52) U.S. Cl. 709/224

(57) ABSTRACT

A medium interface is revealed for connection between an Ethernet LAN controller without a physical (PHY) layer, and other network devices having different kinds of ports, including media independent interface (MII), serial media independent interface (SMII) and gigabit media independent interface (GMII). The interface makes possible a fast, efficient and inexpensive method to test, verify and emulate networks of integrated circuits before silicon is cast, that is, before an application specific integrated circuit (ASIC) is manufactured. The method also allows full test case coverage with high layer protocols.

### FIELD OF THE INVENTION

The present invention relates generally to the field of networking devices, and more particularly the present invention relates to networking devices and methods of networking that are useful for testing integrated circuits made from semiconductors.

### BACKGROUND OF THE INVENTION

Very large scale integrated (VLSI) microcircuits have proven their worth over the past twenty-five years, as an ever-increasing number of functions and controls are available on microcircuits. Entire controllers, or microprocessor controllers, are available on a single computer chip, with the capability of controlling an engine or an automobile, as well as many other applications.

If the potential sales volume for such a circuit is sufficient, or if the performance specifications for such a controller are particularly high, an application specific integrated circuit (ASIC) may be desired. An ASIC is a custom or semi-custom device that includes many functions necessary for fast and reliable controlling or processing, for a particular application. An ASIC may include a microprocessor controller, one or more memories, and also logic devices, including programmable logic devices or arrays (PLDs or PLAs), among other functions. As an example, an ASIC controller may have many inputs and outputs, the inputs including sensor and performance readings, the outputs including commands and signals to a variety of devices that control specific functions of a computer, an engine, an automobile, or an aircraft.

An ASIC is typically manufactured by standard semiconductor manufacturing processes, including complementary metal oxide semiconductor (CMOS) processing, as well as other possible processes. In such devices, performance and speed may be superb, with hard-wired controllers, logic and memory in close proximity. The input and output paths, along with other aspects of the circuit, may be designed to optimize whatever aspect of performance is most desired; and if portions of the circuit are programmable, a user may even change or optimize some aspects of the controller to accommodate changing needs.

One difficulty with ASIC's is that once the photolithographic pattern is made (“the silicon is cast”), it is very difficult to change the circuit. A table of “cuts” and “jumps” sometimes required on prototype boards or chips is an indication of how difficult it is to properly design and test an application-specific integrated circuit. Users may prefer to test such a circuit by simulation, for instance, by creating a prototype on a printed circuit board from several field-programmable gate arrays (FPGAs). The circuit can then be modified by a migration or conversion from FPGAs to the ASIC. The difficulty with such a simulation is that the FPGA often cannot yield the same performance as the ASIC, and thus the performance of the ASIC, while better, is different from the simulation. This defeats the purpose of having a simulation. What is needed is a way to realistically simulate the performance of an ASIC before a manufacturer is committed to a particular configuration, that is, before the ASIC is manufactured.

### BRIEF SUMMARY

The present embodiments meet this need by providing an apparatus and a method for interfacing a device under test, such as an integrated circuit in a data communication device. Circuits tested will most frequently consist of an assembly of FPGAs or other readily-available circuits, connected and programmed to emulate an ASIC. In this manner, a user may “test” an ASIC before manufacture by photolithographic or other expensive, irreversible processes.

One aspect of the invention is an Ethernet media access control (MAC) interface between an Ethernet controller and a test circuit. The interface comprises a data link circuit, connected to the Ethernet controller and the integrated circuit, the data link transmitting and receiving data. A command and control link circuit is also a part of the interface. The interface includes a clock generator system, receiving commands from the command and control link circuit, and sending clock signals. The clock generator system sends a first clock signal to the Ethernet controller, and a second clock signal to the integrated circuit. There is at least one independent interface converter, the converter receiving another clock signal from the clock generating system, and the converter also receiving data from the data link circuit. The converter converts a data stream and transmits the converted data to the data link circuit. There is also a mode select circuit, so that a user of the interface may select which of the at least one independent interface converters to utilize. The mode select circuit receives a mode select signal from the command and control link circuit and sends an enable signal to one of the at least one converters. The clock generator system manipulates the clock signal to the selected and enabled converter, to synchronize data transfer from the test circuit to the Ethernet controller, and from the Ethernet controller to the test circuit.

Another embodiment is a method of interfacing data from a test circuit with an Ethernet controller. The method includes furnishing at least one independent interface converter, and connecting the at least one independent interface converter to the test circuit, to the Ethernet controller, and to a command and control center. The method includes transmitting and receiving data among the test circuit, the independent interface converter, and the Ethernet controller. The method also includes synchronizing the transmitting and receiving by adjusting clock signals to the test circuit, the converter, and the controller. In one embodiment, data to and from the test circuit is in a media independent interface (MII) format, or a serial media independent interface (SMII) format, or in a gigabit media independent interface (GMII) format.

Many other embodiments of the invention are also possible. The devices and method mentioned above are hardware embodiments, utilizing a technique to ratio a frequency of a system or master clock to a frequency of a peripheral clock. Another embodiment involves software or programming techniques to achieve the same conversions, and may be termed a clock-stopping technique.

### BRIEF DESCRIPTION OF SEVERAL VIEWS OF THE DRAWINGS

FIG. 1 is a block diagram of an Ethernet media access control (MAC) interface.

FIG. 2 is a more detailed view of the MAC interface.

FIG. 3 is a block diagram of a test integrated circuit for an MII interface.

FIG. 4 is a depiction of frequencies of clock signals in an MII interface.

FIG. 5 depicts clock frequencies in an SMII interface.

FIG. 6 depicts clock frequencies in a GMII interface.

FIG. 7 is a flow chart for a method of interfacing data between a test circuit and the independent interface.

FIG. 8 depicts a clock-stopping technique for a GMII conversion.

FIG. 9 is a flow chart for a method of testing a test circuit.

FIG. 10 depicts a clock-stopping technique for an SMII conversion.

### DETAILED DESCRIPTION OF THE PRESENTLY PREFERRED EMBODIMENTS

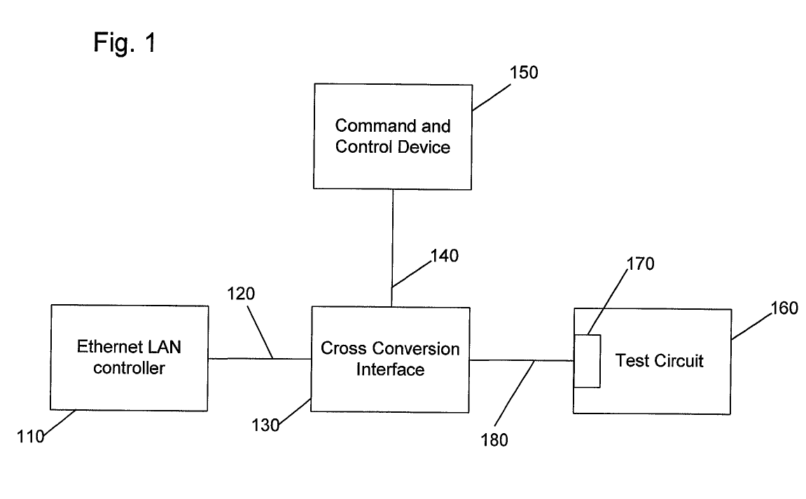

FIG. 1 depicts a cross-conversion independent interface 130. An Ethernet local area network (LAN) controller 110 connects through data link 120 to a cross-conversion interface 130. Cross conversion interface 130 connects additionally to a command and control device 150 through a cable or connector 140 and to a test circuit 160. Test circuit 160 has an interface port 170, through which it connects to the cross conversion interface 130 through data link 180.

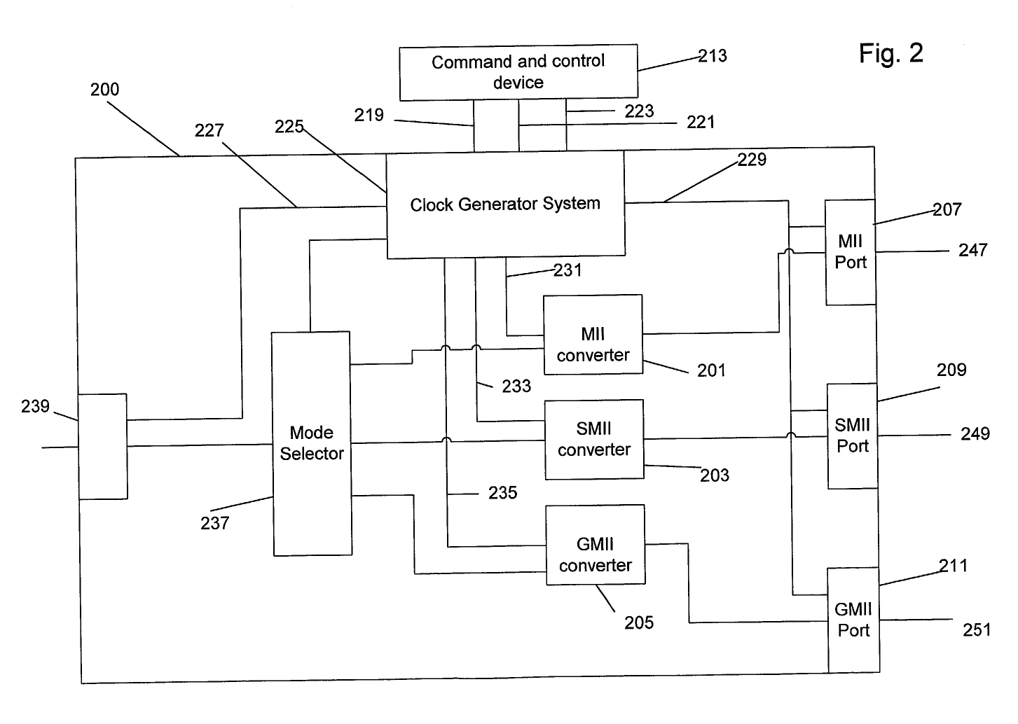

A more detailed version of the interface 200 appears in FIG. 2. In one embodiment, independent interface 200 includes a media independent interface (MII) converter 201, a serial media independent interface (SMII) converter 203, and a gigabit media independent interface (GMII) converter 205. An MII converter converts an MII data stream into an MII data stream. An SMII converter converts an SMII data stream to an MII data stream, and also converts an MII data stream to an SMII data stream. A GMII converter converts a GMII data stream to an MII data stream, and also converts an MII data stream to a GMII data stream. Data links 120 and 180, connecting the interface to the Ethernet LAN controller and the device under test, comprise a data link circuit.

The interface 200 includes a port for each converter, through which the interface connects with a circuit to be tested (not shown). MII converter 201 connects to MII port 207, SMII converter 203 connects to SMII port 209, and GMII converter 205 connects to GMII port 211. Command and control device 213 transmits signals and commands to the media independent interface 200 and its components, including the clock generator system 225 and the ports, 207, 209, 211. The signal lines include a mode select signal line 219, a master clock signal line 221, and a reset signal line 223. The clock generator system 225 may take a master clock signal of one frequency, and may generate clock signals of different frequencies. The clock generator system 225 sends a first clock signal through System Clock 1 line 227 to MII port 239 and thence to the Ethernet controller (not shown). The clock generator system sends a second clock signal through System Clock 2 line 229 to MII port 207, SMII port 209 and GMII port 211. The signals on system clock 1 line 227 and system clock 2 line 229 will be referred to as system clock 1 and system clock 2. These signals may have a frequency different from the master clock frequency signal sent on master clock frequency line 221.

The clock generator also generates and sends clock signals to the converters 201, 203, and 205. In one embodiment, separate lines 231, 233 and 235 may connect the converters to the clock generator, so that the clock generator may send signals of different frequency on the different lines to the different converters. These signals may include an MII clock signal sent to MII converter 201 on line 231, an SMII clock signal sent to SMII converter 203 on line 233, and a GMII clock signal sent to GMII converter 205 on line 235. A mode select signal from mode select signal line 219 is routed to a mode selector 237.

The mode select signal enables one of the modes of operation of the cross-conversion interface 200, either an MII mode utilizing MII converter 201, an SMII mode utilizing SMII converter 203, or a GMII mode utilizing GMII converter 205. The mode selector receives at least one mode-select signal from the command and control device 213, which determines which of the converters is used. The mode-select signal enables one converter and disables the other converters. The mode selector may also provide the data transmit and receive paths for data to and from the selected converter and the MII port 239 to the Ethernet LAN controller (not shown). Typically, the mode selector switch is a multiplexer/demultiplexer, having data paths to all converters in the interface. The mode selector switch also provides paths for all other connectors and signal lines used between the Ethernet LAN controller and the converters. These paths include, but are not limited to, data transmit and receive lines, receive delimiter, transmit delimiter, carrier sense signal, transmit error signals, and a transmit synchronization signal. In some embodiments, return lines for the signal paths are also provided.

The interface 200 may also include connectors 247, 249 and 251, respectively for MII, SMII and GMII interfaces. Typically, an MII connector will utilize 4-bit data pairs for data transmit and receive, and an MII signal will include 2 parallel control bits and 4 parallel data bits. Typically, an SMII connector will utilize a 1-bit data pair for data transmit and receive, with 2 serial control bits and 8 serial data bits, while a GMII connector will utilize 8-bit data-pairs for data transmit and receive, with 2 parallel control bits and 8 parallel data bits. Thus, if MII is a base rate for data exchange, SMII will be five times as fast as MII while GMII will be one-half as fast as MII. It is this difference that should be addressed by an interface. The connectors may also utilize other wires, such as for transmit and receiver delimiter signals, transmit and receive synchronization signals, a transmit error signal, a receive carrier sense signal and a clock signal.

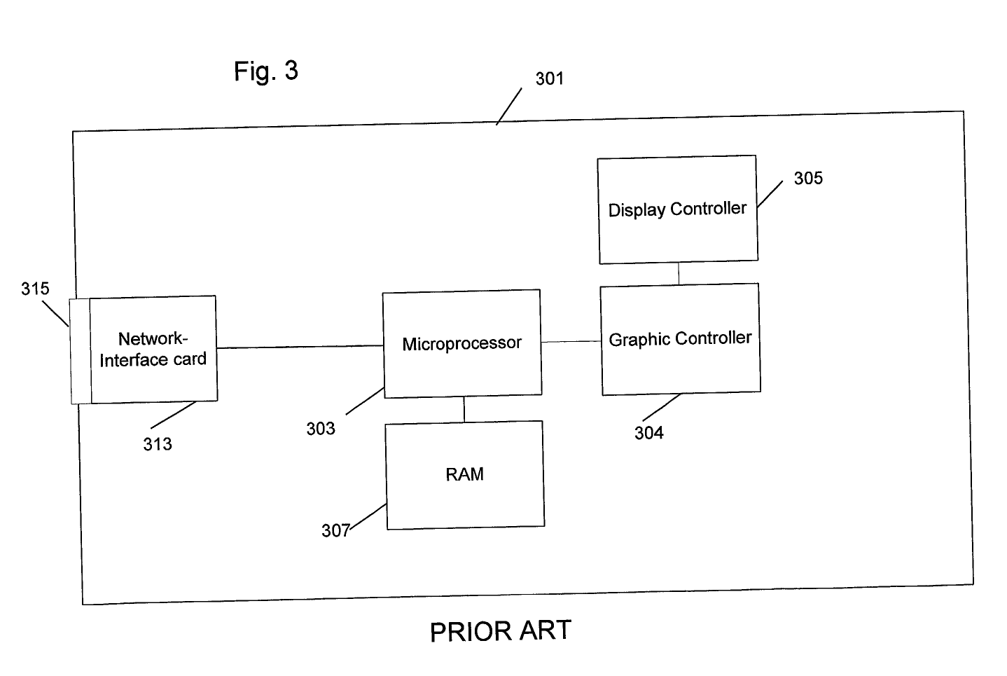

Testing may be desired, for example on a circuit to control, display, and transmit and receive medical imaging, simulating the performance of an ASIC which will be manufactured after a desired level of performance is achieved. While the circuit is primarily meant to test digital transmission, the circuit for which testing is desired may include numerous related circuits, including one or more memories, a microprocessor, a graphic controller and a display controller. In the particular circuit embodiment 301 depicted in FIG. 3, a microprocessor 303 is included, along with network interface card 313, graphic controller 304, display controller 305 and random access memory 307. The input and output of the circuit are accomplished through independent interface port 315. In one embodiment of the invention, the port 315 may be a media independent interface (MII) port, or a serial media independent interface (SMII) port, or a gigabit media independent interface (GMII) port.

The port and the system selected for the device under test should be appropriate for the circuit and its purpose, and commensurate with the speed requirements for data input/output. The rationale for having a device with a plurality of interfaces is that the device or circuit tested should use the same port and interface that is intended for the device in actual service. Thus, an Ethernet LAN controller utilizing an MII card may be near or may be remote from the device under test, and may transmit and receive data at a base rate. If the Ethernet LAN wishes to connect with the independent interface converter using SMII mode, the converter will be able to send and receive data at a much slower rate, since SMII mode is inherently slower.

The interface accomplishes its task of converting data from one format to another by synchronizing the signals to and from the Ethernet LAN controller and the device under test. In one embodiment, the command and control system send a master clock signal to a clock generating system. The master clock signal, or another signal generated in the clock generating system, should be the fastest clock used, that is, this signal should have the highest frequency. In one embodiment, this frequency could be as high as hundreds of MHz; in other embodiments it may be a very low frequency, depending on the speed achievable by the test circuit.

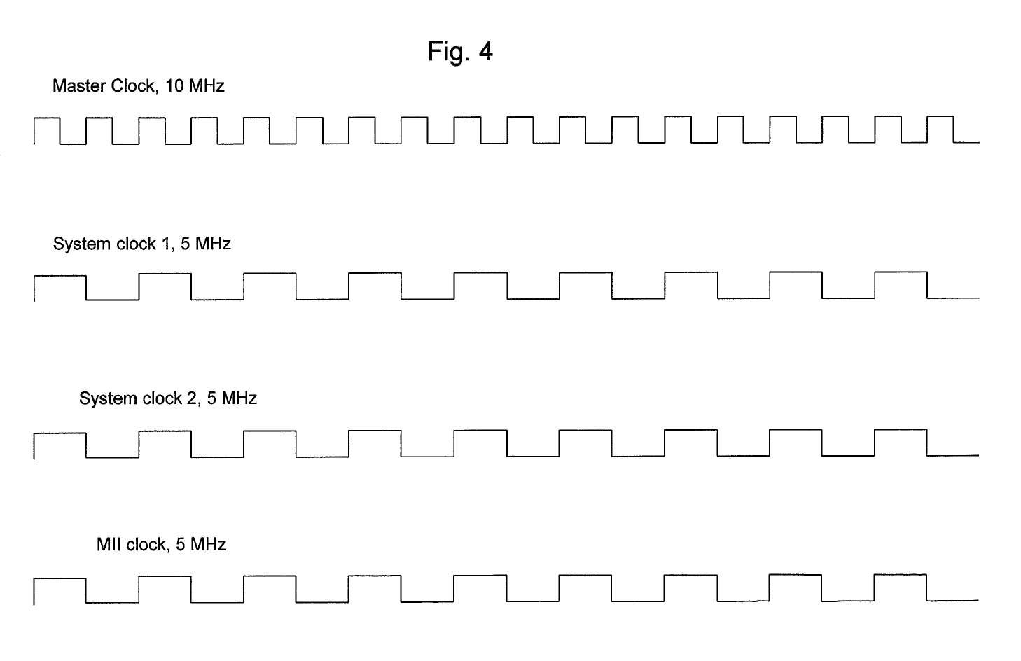

The clock generating system then generates a plurality of other clock signals, used for the Ethernet LAN controller, the interface, and the device under test. The signals used will depend on the mode selected by a user, that is, whether the user wishes to send and receive data according to an MII format, an SMII format, or a GMII format. In one embodiment, a user selects an MII format. The clock generator uses a master clock frequency of 10 MHz and sends a system clock 1 signal of 5 MHz through an MII port to the Ethernet LAN controller. The clock generator send a system clock 2 signal of 5 MHz through an MII port to the device under test, and also sends an MII clock signal of 5 MHz to the MII converter. Because the data is converted to and from the MII format, the system clock 1, system clock 2 and MII clocks all run at the same speed. In this embodiment, that speed is one-half the master clock frequency. The signals are depicted in FIG. 4.

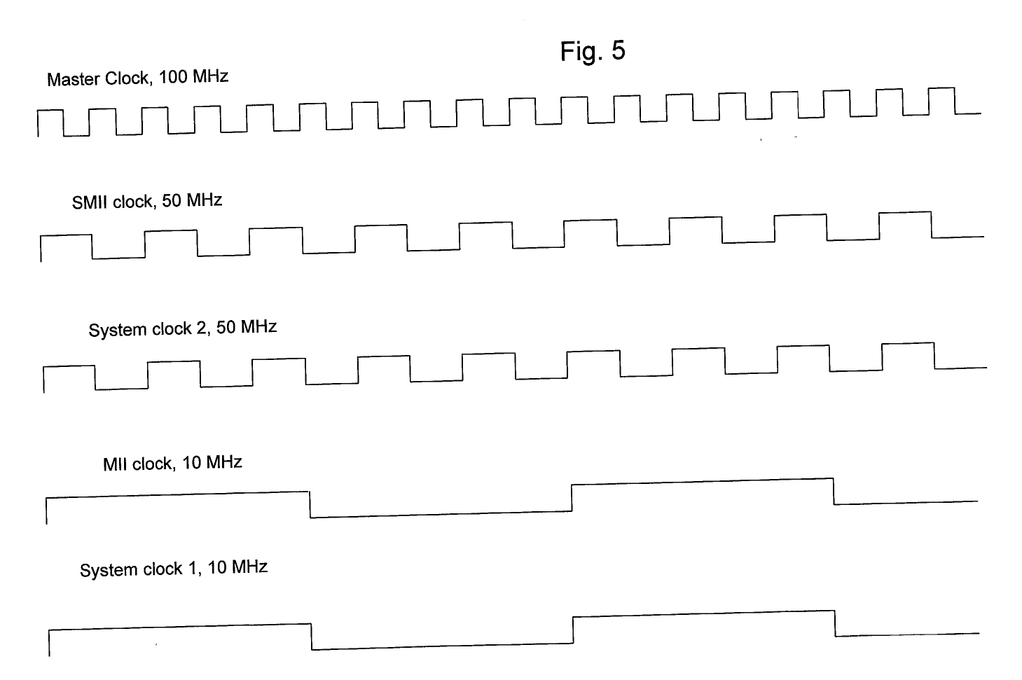

In another embodiment, the SMII mode is selected. The SMII clock signal runs at one-half the master clock frequency, and the MII clock signal runs at one-tenth the master clock frequency. The situation is depicted in FIG. 5. The master clock frequency, in one embodiment, is 100 MHz. The SMII clock frequency is one-half this rate, 50 MHz, and the MII clock frequency is 10 MHz, one-tenth that of the master clock. System clock one runs at one-tenth the frequency, 10 MHz, and system clock 2 runs at one-half the master clock frequency, 50 MHz. System clock one may be run at another frequency, near 10 MHz or substantially 10 MHz, with system clock 2 preferably 5 times as fast as system clock 1. Other frequencies may be used, but these clock rates best use the time and the available bandwidth of the connectors and the interfaces available. MII frequencies are not limited to 10 MHz, and in other embodiments may be as high as 20-25 MHz or higher.

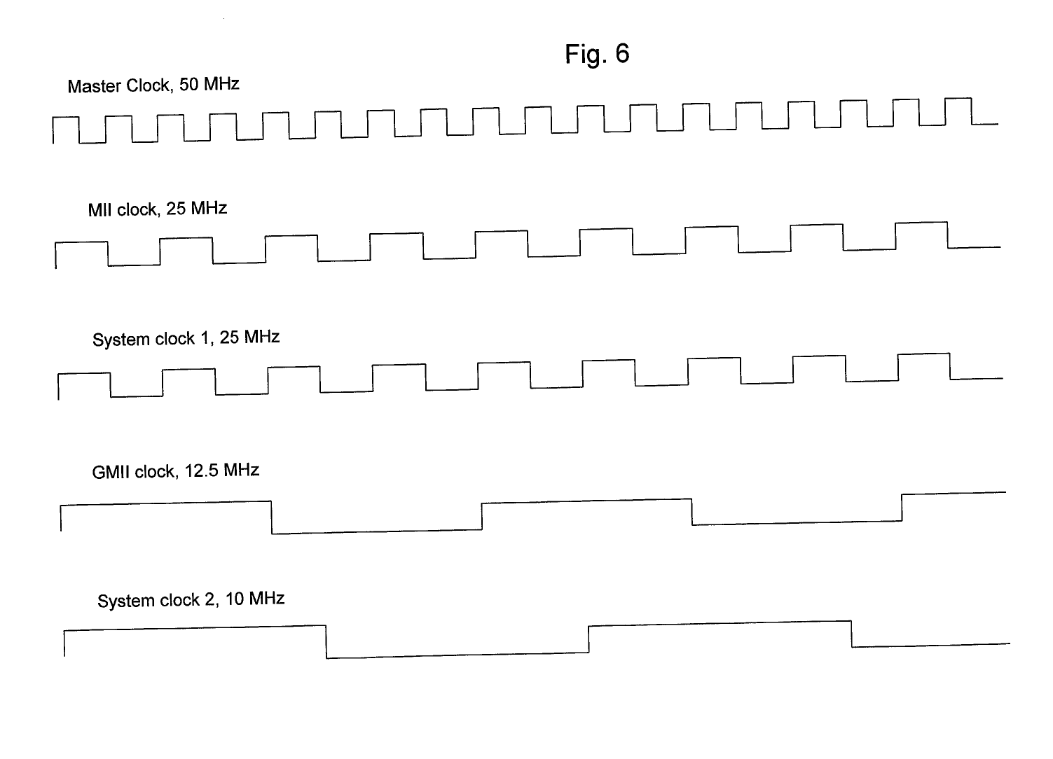

In another embodiment, the GMII mode is selected. The GMII clock signal runs at one-fourth the master clock signal frequency, and the MII clock signal is one-half the master clock signal frequency. System clock one is one-half the frequency of the master clock frequency and system clock two is one-fifth the frequency of the master clock signal. This configuration assumes that the device under test uses system clock 2 as the master clock, and that the GMII interface for the device under test uses the GMII clock. The other system is the test environment that only uses an MII interface. The MII clock is run twice as fast as the GMII clock to allow the MII port (a fast Ethernet port) to drive the gigabit Ethernet port traffic in order to test the gigabit Ethernet port. Doubling the clock rate allows two 4-bit data sequences (MII) to drive the 8-bit GMII data while maintaining the same data bit rate. In one embodiment, depicted in FIG. 6, the master clock frequency is 50 MHz, the GMII signal frequency is 12.5 MHz, the MII clock signal runs at 25 MHz, system clock 1 runs at 25 MHz and system clock 2 runs at 10 MHz. Other frequencies may be used.

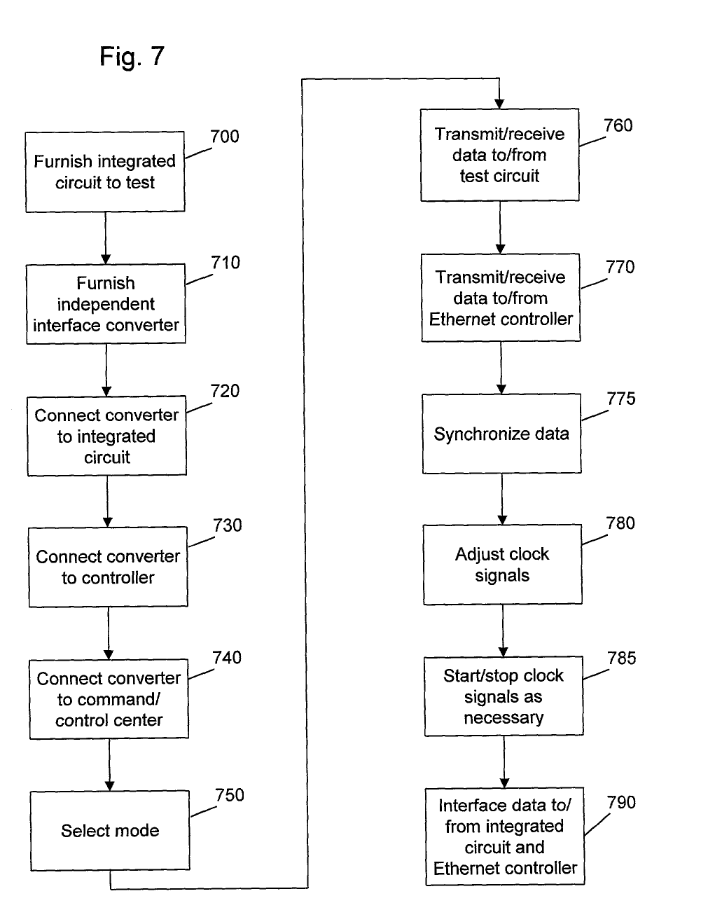

One method of converting data is depicted in FIG. 7. A user furnishes a device, such as an integrated circuit 700, preferably with a connector designed for wires used in embodiments of the selected mode. The user then furnishes an interface converter 710, such as a media independent interface (MII) converter, or a serial media independent interface (SMII) converter, or a gigbit media independent interface (GMII). The user connects the selected converter to the device or integrated circuit 720, and also connects the converter to an Ethernet LAN controller 730 and to a command and control center 740. The user selects a mode for data transmitting and receiving 750, namely a mode that uses an MII converter, an SMII converter, or a GMII converter. This selection is transmitted to the command and control center and to the cross conversion interface. Data is then transmitted to and from the device 760, and to and from the Ethernet LAN controller 770. The data transfer is synchronized 775 by using the different clock mentioned above. In one example, if an SMII mode is used, the device may transmit data at a rate of 10 MHz. In order for the MII converter to transmit data at the same rate, it uses a clock signal of 2 MHz. The clock generating system, working with the command and control device, and the SMII converter, adjusts the clock rates 780, accumulates data from the device under test under an SMII format, converts it to MII format at a slower rate, and interfaces data to and from the integrated circuit and the Ethernet LAN controller 790. The process works in reverse for sending data, such as commands, test cycles, start or stop orders, from the Ethernet LAN controller to the device.

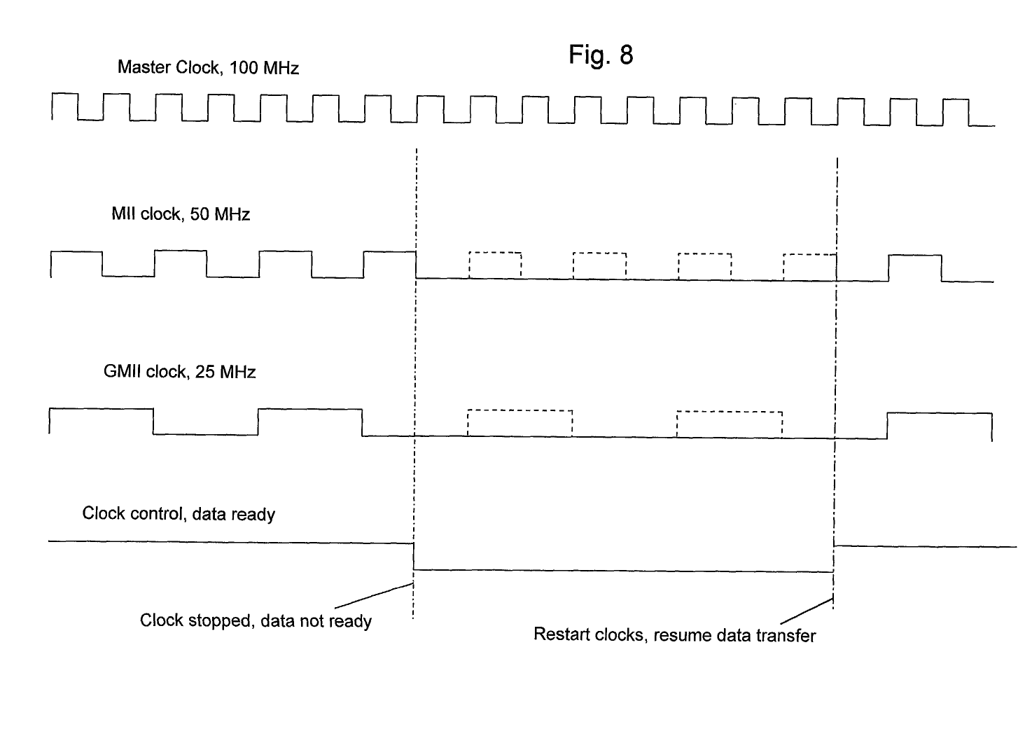

In another way of converting data from one format to another, a clock-stopping technique may be used 785. In this method, a clock control (data ready) signal from a computer program enables the selected converter to continue its conversion until the data ready signal is changed. One embodiment may be a device or clock driver in which a “data ready” signal is generated by a computer program or software. The computer program may be entered into permanent or read-only memory, or entered and stored by any of a variety of means. The technique is illustrated for MII to GMII conversion in FIG. 8. In one example, the master clock is set to 100 MHz, the GMII clock and the system clock 2 run at 25 MHz, and the MII and system clock 1 run at 50 MHz. The method prevents overflow and loss of data if the converter is not be able to keep up with the flow of data. The data ready signal goes low, as shown in FIG. 8, preferably at the non-sampling edge of the fastest clock (master clock, 100 MHz), just before the next fastest clock (MII) sampling edge. The method stops both the MII clock and the GMII clock, thus making the stop transparent to both the Ethernet LAN controller and the device or integrated circuit being tested. When the data is ready, the next clock edge encountered (from the master clock) will re-start both clocks, as if there had been no interruption. In this technique, the data from both sides of the conversion are being sampled and time is made available for the conversion. Since both the MII (Ethernet LAN controller) and GMII (device or integrated circuit) clocks are stopped, no data is lost. It is also clear that the devices may be operated at any desired frequency consistent with the circuits, circuit boards, connectors and controllers selected.

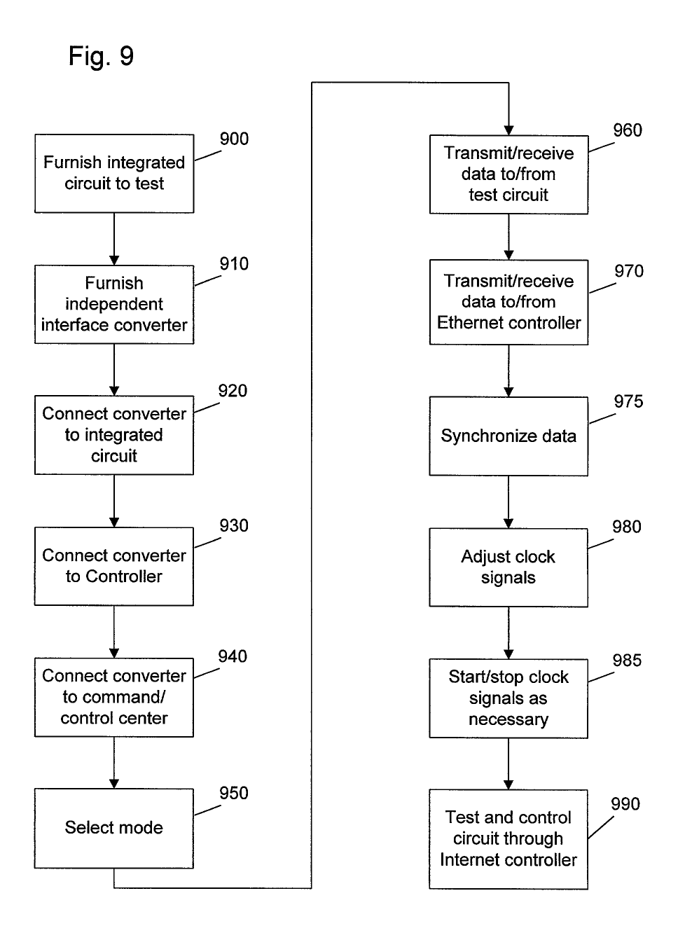

Another embodiment is a method of testing a circuit by means of an Ethernet LAN controller, the method depicted in FIG. 9. A user furnishes a device 900, typically an integrated circuit that the user desires to test. The user furnishes a data interface converter, typically an MII converter, an SMII converter or a GMII converter 910. In one embodiment, an interface between a device and an Ethernet LAN controller contains circuits suitable for each of these converters. The user then connects the interface converter to the integrated circuit 920 of device being tested, and also connects the LAN controller to the converter 930. In one embodiment, the user also connects a command and control center to the interface converter 940. The command and control center may be a part of the LAN controller. A mode, MII, SMII or GMII mode, is selected 950. The user then transmits and receives data to and from the test circuit or integrated circuit 960, and also transmits and receives data to and from the Ethernet LAN controller 970. The data is synchronized 975 by adjusting the frequencies of the clocks 980 used by the parts of the test system. As one example, if the test circuit and mode selected are GMII mode, and the clock to the GMII converter is 50 MHz, then the clock to the MII converter must be 100 MHz. The converter will convert twice-as-wide data from the GMII format into the MII format, and send the data to the LAN controller. In reverse, the converter will accumulate data from two cycles of MII format to one cycle of twice-as-wide data (data width) for GMII format. The user than proceeds to test and control the circuit through the Ethernet LAN controller and the interface converter 990.

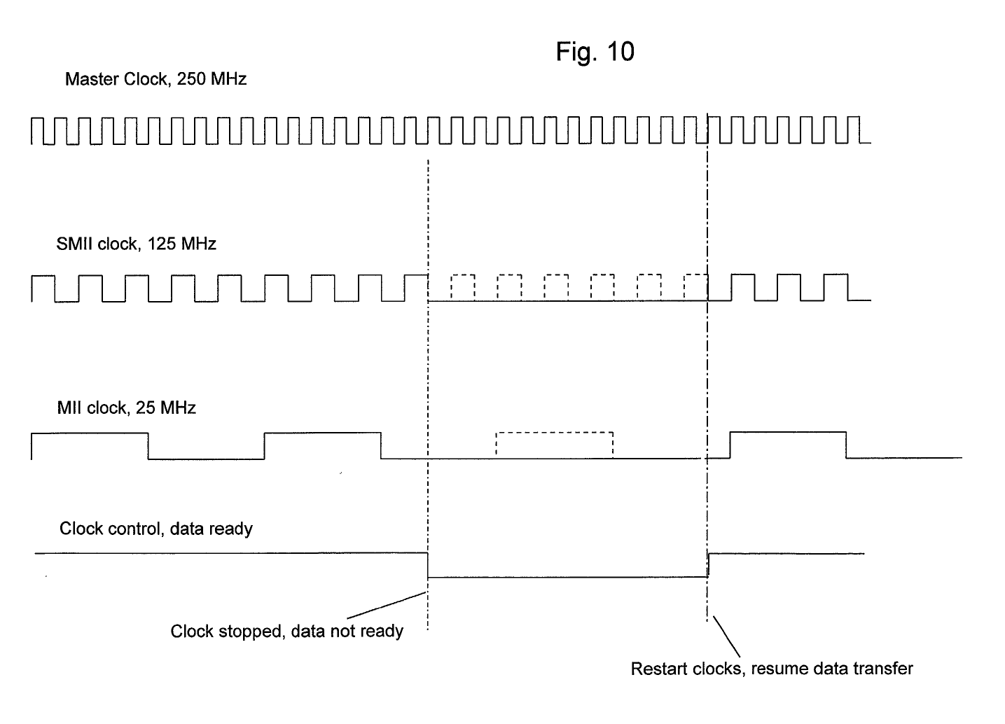

In another way of converting data from one format to another, a clock-stopping technique may be used 985. In this method, a clock control (data ready) signal from a computer program enables the selected converter to continue its conversion until the data ready signal is changed. One embodiment may be a device or clock driver in which a “data ready” signal is generated by a computer program or software. The computer program may be entered into permanent or read-only memory, or entered and stored by any of a variety of means. The technique is illustrated for MII to SMII conversion in FIG. 10. In one example, the master clock is set to 250 MHz, the SMII clock and the system clock 2 run at 125 MHz, and the MII and system clock 1 run at 25 MHz. The method prevents overflow if the converter is not be able to keep up with the flow of data. The data ready signal goes low, as shown in FIG. 10, preferably at the non-sampling edge of the fastest clock (master clock, 250 MHz), just before the next fastest clock (SMII) sampling edge, as shown in FIG. 10. The method stops both the MII clock and the SMII clock, thus making the stop transparent to both the Ethernet LAN controller and the device or integrated circuit being tested. When the data is ready, the next clock edge encountered (from the master clock) will re-start both clocks, as if there had been no interruption. In this technique, the data from both sides of the conversion are being sampled and time is made available for the conversion. Since both the MII (Ethernet LAN controller) and SMII (device or integrated circuit) clocks are stopped, no data is lost. It is also clear that the devices may be operated at any desired frequency consistent with the circuits, circuit boards, connectors and controllers selected.

Although only a few embodiments of the invention have been discussed, other embodiments are contemplated. For example, other frequencies may be used, and other media independent interfaces may be used in generating or receiving data from a circuit. It is therefore intended that the foregoing description illustrates rather than limits this invention, and that it is the following claims, including all equivalents, which define this invention. Of course, it should be understood that a wide range of changes and modifications may be made to the embodiments described above. Accordingly, it is the intention of the applicants to protect all variations and modifications within the valid scope of the present invention.

What is claimed is:

1. An Ethernet media access control (MAC) interface connectable between an Ethernet controller and a circuit under test, comprising:
a data link circuit connectable to the Ethernet controller and the circuit under test, the data link transmitting and receiving data;
a command and control link circuit;
a clock generator system, receiving commands from the command and control link circuit and sending a first clock signal to the Ethernet controller, and a second clock signal to the circuit under test;
at least one independent interface converter, receiving a clock signal from the clock generating system, said converter also receiving data from the data link circuit, converting a data stream, and transmitting said converted data to the data link circuit; and
a mode select circuit, receiving a mode select signal from the command and control link circuit and sending an enable signal to a converter,
wherein the clock generator system manipulates the clock signal to an enabled converter to synchronize data transfer from the circuit under test to the Ethernet controller.

2. The interface of claim 1, wherein the at least one converter is selected from the group consisting of a first converter, a second converter and a third converter, the first converter converting a media independent interface (MII) data stream to a serial media independent interface (SMII) data stream and also converting an SMII data stream to an MII data stream, the second converter converting an MII data stream to a gigabit media independent interface (GMII) and also converting a GMII data stream to an MII stream, and the third converter converting an MII data stream to an MII data stream.

3. The interface of claim 1, further comprising a first MII connector connected to the data link circuit, and a second connector connected to the data link circuit, said second connector selected from the group consisting of an MII connector, a GMII connector, and an SMII connector.

4. The interface of claim 1, wherein the command and control link circuit receives and transmits signals selected from the group consisting of a master clock signal, a system clock signal, a reset signal and a mode select signal.

5. The interface of claim 2, wherein the at least one independent interface converter comprises a first converter converting an MII data stream to a SMII data stream and also converting an SMII data stream to an MII data stream, a frequency of the first clock signal is substantially one-tenth a frequency of a master clock signal, a frequency of the second clock signal is one-half a frequency of the master clock signal, and the frequency of the clock signal to the first converter is one-half the frequency of the master clock signal.

6. The interface of claim 2, wherein the at least one independent interface converter comprises a second converter converting an MII data stream to a GMII data stream and also converting an GMII data stream to an MII data stream, a frequency of the first clock signal is substantially one-half a frequency of a master clock signal, a frequency of the second clock signal is one-fifth a frequency of the master clock signal, and the frequency of the clock signal to the second converter is one-fourth the frequency of the master clock signal.

7. The interface of claim 2, wherein the at least one independent interface converter comprises a third converter converting an MII data stream to a MII data stream, a frequency of the first clock signal is one-half a frequency of a master clock signal, a frequency of the second clock signal is one-half a frequency of the master clock signal, and the frequency of the clock signal to the third converter is one-half the frequency of the master clock signal.

8. The interface of claim 5, further comprising an SMII crossover cable connecting said first converter with the data link circuit.

9. The interface of claim 6, further comprising a GMII crossover cable connecting said second converter with the data link circuit.

10. The interface of claim 7, further comprising an MII crossover cable connecting said third converter with the data link circuit.

11. A method of converting data from a circuit with an Ethernet controller, the method comprising:
connecting at least one independent interface converter to the circuit, to the Ethernet controller, and to a command and control center;
transmitting and receiving data among the circuit, the interface converter, and the Ethernet controller; and
synchronizing the transmitting and receiving by adjusting clock signals to the circuit, the interface converter, and the Ethernet controller,
wherein the data from the circuit is in a format selected from the group consisting of media independent interface (MII), serial media independent interface (SMII), and gigabit media independent interface (GMII).

12. The method of claim 11, wherein the Ethernet controller receives and transmits data in an MII format.

13. The method of claim 11, wherein the method further comprises synchronizing by using a fraction of a frequency of a master clock signal as a clock signal to the circuit under test.

14. The method of claim 11, wherein the method further comprises synchronizing by stopping and starting said clock signals.

15. The method of claim 11, wherein the method further comprises selecting a mode, wherein selecting the mode also selects a format for an independent interface.

16. A method of testing a circuit, the method comprising:
furnishing a circuit;
connecting the circuit to an independent interface converter;
synchronizing the circuit with the converter;
transmitting and receiving data from the circuit and the converter; and
controlling the circuit with an Ethernet LAN controller,
wherein the controller tests the circuit by synchronizing a speed of the Ethernet LAN controller with a speed of the circuit and wherein data from the device is in a format selected from the group consisting of a media independent interface (MII), a serial media independent interface (SMII), and a gigabit media independent interface (GMII).

17. The method of claim 16, wherein the synchronizing occurs by furnishing a first clock signal to the Ethernet LAN controller, a second clock signal to the converter, and a third clock signal to the circuit.

18. The method of claim 17, wherein the synchronizing occurs by stopping and starting a clock for at least one of said first, second and third clock signals.

19. The method of claim 17, further comprising wherein the method further comprises selecting a mode, wherein selecting the mode also selects a format for an independent interface.

20. The method of claim 16, wherein the Ethernet controller receives and transmits data in an MII format.
